(19) United States
(12) Patent Application Publication
(10) Pub. No.: US 2020/0032687 A1
(43) Pub. Date: Jan. 30, 2020

(54) MULTI-LAYER NITROGEN OXIDE STORAGE CATALYST WITH MANGANESE

(71) Applicant: UMICORE AG & CO. KG

(72) Inventors: Thomas UTSCHIG, Frankfurt am Main (DE); Elena MUELLER, Pfungstadt (DE); Ruediger HOYER, Alzenau-Hoerstein (DE)

(73) Assignee: UMICORE AG & CO. KG, Hanau-Wolfgang (DE)

(21) Appl. No.: 16/074,164

(22) PCT Filed: Feb. 1, 2017
(86) PCT No.: PCT/EP2017/052081

§ 371 Date: Jul. 31, 2018

(30) Foreign Application Priority Data
Feb. 2, 2016 (DE) 10 2016 101 761.2

(51) Int. Cl. F01N 3/08; B01D 53/94; B01J 23/58; B01J 23/63; B01J 23/656; B01J 35/00; B01J 37/02; B01J 37/03

(52) U.S. Cl. CPC F01N 3/0814; F01N 2510/0684; B01D 53/9422; B01J 23/58; B01J 23/63; B01J 23/6562; B01J 35/0006; B01J 35/0073; B01J 37/0244; B01J 37/038; B01D 2255/1021; B01D 2255/1023; B01D 2255/1025; B01D 2255/202; B01D 2255/2042; B01D 2255/2047; B01D 2255/2063; B01D 2255/2065; B01D 2255/2073; B01D 2255/2092; B01D 2255/9022; B01D 2255/91; B01D 2258/012; B01J 2523/00; F01N 2370/02; F01N 3/0842

(57) ABSTRACT

The Invention relates to a nitrogen oxide storage catalyst composed of at least two catalytically-active washcoat layers on a support body, wherein a lower washcoat layer A comprises cerium oxide, an alkaline earth metal compound and/or an alkali compound, platinum and palladium, and manganese oxide, and an upper washcoat layer B disposed on the washcoat layer A comprises cerium oxide, platinum and palladium and does not contain any alkali and alkaline-earth compounds, and to a method for converting NOₓ in exhaust gases from motor vehicles which are operated with lean-burn engines.

The present invention relates to a catalyst for the reduction of nitrogen oxides contained in the exhaust gas of lean-burn combustion engines.

The exhaust gas of motor vehicles that are operated with lean-burn combustion engines, such as with diesel engines, also contains, in addition to carbon monoxide (CO) and nitrogen oxides (NOₓ), components that result from the incomplete combustion of the fuel in the combustion chamber of the cylinder. In addition to residual hydrocarbons (HC), which are usually also predominantly present in gaseous form, these include particle emissions, also referred to as “diesel soot” or “soot particles”. These are complex agglomerates from predominantly carbonaceous particulate matter and an adhering liquid phase, which usually preponderantly consists of longer-chained hydrocarbon condensates. The liquid phase adhering to the solid components is also referred to as “Soluble Organic Fraction SOF” or “Volatile Organic Fraction VOF.”

To clean these exhaust gases, the aforementioned components must be converted to harmless compounds as completely as possible. This is only possible with the use of suitable catalysts.

In order to remove the nitrogen oxides, so-called nitrogen oxide storage catalysts are known, for which the term, “Lean NOx Trap”, or LNT, is also common. Their cleaning action is based upon the fact that in a lean operating phase of the engine, the nitrogen oxides are predominantly stored in the form of nitrates by the storage material of the storage catalyst, and the nitrates are broken down again in a subsequent rich operating phase of the engine, and the nitrogen oxides which are thereby released are converted with the reducing exhaust gas components in the storage catalyst to nitrogen, carbon dioxide, and water. This operating principle is described in, for example, SAE document SAE 950809.

As storage materials, oxides, carbonates, or hydroxides of magnesium, calcium, strontium, barium, alkali metals, rare earth metals, or mixtures thereof come, in particular, into consideration. As a result of their alkaline properties, these compounds are able to form nitrates with the acidic nitrogen oxides of the exhaust gas and to store them in this way. They are deposited in the most highly-dispersed form possible on suitable substrate materials in order to produce a large interaction surface with the exhaust gas. In addition, nitrogen oxide storage catalysts contain precious metals, such as platinum, palladium, and/or rhodium as catalytically-active components. It is their purpose, on the one hand, to oxidize NO to NO₂, as well as CO and HC to CO₂, under lean conditions and, on the other hand, to reduce released NO₂ to nitrogen during the rich operating phases, in which the nitrogen oxide storage catalyst is regenerated.

With the change in the emission regulations according to Euro 6, future exhaust gas systems will have to exhibit sufficient NOₓ conversion, both at low temperatures in urban cycles and at high temperatures such as occur with high loads. Known nitrogen oxide storage catalysts, however, do not show a marked NOₓ storage at low or high temperatures. There is a need for catalysts that provide good NOₓ conversion over a broad temperature range of 200 to 450° C.

EP 0 885 650 A2 describes an exhaust gas purification catalyst for combustion engines with two catalytically-active layers on a support body. The layer located directly on the support body comprises one or more highly-dispersed alkaline earth oxides, at least one platinum group metal, as well as at least one fine-particle oxygen-storing material. In this case, the platinum group metals are in close contact with all components of the first layer. The second layer is in direct contact with the exhaust gas and contains at least one platinum group metal, as well as at least one fine-particle oxygen-storing material. Only a portion of the fine-particle solids of the second layer serves as a substrate for the platinum group metals. The catalyst is a three-way catalyst, which essentially converts the harmful exhaust gas components under stoichiometric conditions, i.e., with the air/fuel ratio λ of 1.

From US2009/320457, a nitrogen oxide storage catalyst is known that comprises two superimposed catalyst layers on a support substrate. The lower layer lying directly on the carrier substrate comprises one or more precious metals, as well as one or more nitrogen oxide storage components. The upper layer comprises one or more precious metals, as well as cerium oxide, and is free of alkali or alkaline earth components.

Catalyst substrates which contain nitrogen oxide storage materials and have two or more layers are also described in WO 2012/029050. The first layer is located directly on the carrier substrate and comprises platinum and/or palladium, while the second layer is located on the first layer and comprises platinum. Both layers also contain one or more oxygen-storing materials and one or more nitrogen oxide-storing materials, which comprise one or more alkali metals and/or alkaline earth metals. The total quantity of alkali metals and alkaline earth metals in the nitrogen oxide-storing materials is 11.25 to 156 (0.18 to 2.5 g/in³), calculated as alkaline metal oxide M₂O and alkaline earth metal oxide MO.

It is already known to use manganese compounds—in particular, manganese oxide—as components of catalysts for automobile exhaust gas catalysis.

DE102011109200A1 and US2015/165422, for example, thus describe manganiferous diesel oxidation catalysts.

DE102012204524A1 describes LNT catalysts containing manganiferous mixed oxides, e.g., MnOₓ—CeO₂. US2013/336865 also describes NOₓ absorber catalysts containing manganese.

The present invention relates to a nitrogen oxide storage catalyst composed of at least two catalytically-active washcoat layers on a support body, wherein
a lower washcoat layer A contains cerium oxide, an alkaline earth compound and/or an alkali compound, platinum and palladium, as well as manganese oxide; and
an upper washcoat layer B arranged above washcoat layer A contains cerium oxide, as well as platinum and palladium, and is free of alkali compounds or alkaline earth compounds.

The cerium oxide used in washcoat layers A and B can be of a commercially available quality, i.e., have a cerium oxide content of 90 to 100 wt %.

In embodiments of the present invention, cerium oxide is used in washcoat layer A in a quantity of 110 to 160 g/L, e.g., 125 to 145 g/L. In washcoat layer B, cerium oxide is used in quantities of 22 to 120 g/L, e.g., 40 to 100 g/L or 45 to 65 g/L.

Suitable as alkaline earth compound in washcoat layer A are, in particular, oxides, carbonates, and/or hydroxides of magnesium, strontium, and/or barium—particularly, magnesium oxide, barium oxide, and strontium oxide.

Suitable as alkali compound in washcoat layer A are, in particular, oxides, carbonates, and/or hydroxides of lithium, potassium, and/or sodium.

In embodiments of the present invention, the alkaline earth or alkali compound in washcoat layer A is present in quantities of 10 to 50 g/L—particularly, 15 to 20 g/L—calculated as alkaline earth or alkali oxide and in relation to the volume of the support body.

In embodiments of the present invention, manganese oxide is present in washcoat layer A in quantities of 1 to 10 wt %—preferably, 2.5 to 7.5 wt %—in relation to the total of washcoat layers A and B, respectively calculated as MnO.

In other embodiments, washcoat layer B also contains manganese oxide. In these cases, the quantity of manganese oxide in washcoat layer B is up to 2.5 wt % preferably, 0.5 to 2.5 wt %—in relation to the total of washcoat layers A and B.

In preferred embodiments of the present invention, manganese oxide does not serve as substrate material—neither for the precious metals, platinum, palladium, and, where applicable, rhodium nor for another component of washcoat layer A and, where applicable, washcoat layer B.

The term, “manganese oxide,” in the context of the present invention refers, in particular, to MnO, MnO₂, or Mn₂O₃, or combinations of MnO₂, MnO, and/or Mn₂O₃.

In embodiments of the present invention, manganese oxide is not present in the form of mixed oxides with other oxides of washcoat layers A and B. Manganese oxide is, in particular, not present in the form of a mixed oxide with cerium oxide, e.g., not in the form of MnOₓ—CeO₂, MnO—ZrO₂, and MnOₓ—Y₂O₃.

The ratio of platinum to palladium in washcoat layer A in embodiments of the present invention amounts to, for example, 4:1 to 18:1 or 6:1 to 16:1, e.g., 8:1, 10:1, 12:1, or 14:1.

The ratio of platinum to palladium in washcoat layer B in embodiments of the present invention also amounts to, for example, 4:1 to 18:1 or 6:1 to 16:1, e.g., 8:1, 10:1, 12:1, or 14:1, but depends upon the ratio in washcoat layer A.

In embodiments of the present invention, washcoat layer B contains rhodium as an additional precious metal. In this case, rhodium is present, in particular, in quantities of 0.003 to 0.35 g/L (0.1 to 10 g/ft³)—in particular, 0.18 to 0.26 g/L (5 to 7.5 g/ft³)—respectively in relation to the volume of the support body.

The total quantity of precious metal, i.e., of platinum, palladium, and, where applicable, rhodium, in the nitrogen oxide storage catalyst according to the invention amounts, in embodiments of the present invention, to 2.12 to 7.1 g/L (60 to 200 g/ft³) in relation to the volume of the support body.

The precious metals, platinum and palladium, and, where applicable, rhodium, are usually present on suitable substrate materials in both washcoat layer A and washcoat layer B. Used as such substrate materials are, in particular, oxides with a BET surface of 30 to 250 m²/g—preferably, of 100 to 200 m²/g (determined in accordance with DIN 66132)—e.g., aluminum oxide, silicon dioxide, titanium dioxide, but also mixed oxides, such as aluminum-silicon mixed oxides and cerium-zirconium mixed oxides. In embodiments of the present invention, aluminum oxide is used as substrate material for the precious metals platinum and palladium, and, where applicable, rhodium—in particular, such aluminum oxide as is stabilized by 1 to 6 wt %—in particular, 4 wt %—lanthanum oxide.

It is preferable for the precious metals, platinum, palladium, and, where applicable, rhodium to be carried on only one or more of the aforementioned substrate materials, and thus not to be in close contact with all components of the respective washcoat layer. In particular, manganese oxide preferably does not serve as substrate for platinum and palladium and, where applicable, rhodium.

The total washcoat loading of the support body in embodiments of the present invention amounts to 300 to 600 g/L in relation to the volume of the support body.

In a preferred embodiment, the present invention relates to a nitrogen oxide storage catalyst composed of at least two catalytically-active washcoat layers on a support body, wherein
a lower washcoat layer A contains
   cerium oxide in a quantity of 100 to 160 g/L,
   platinum and palladium in a mass ratio of 10:1,
   magnesium oxide and/or barium oxide; as well as
   manganese oxide in a quantity of 10 to 20 g/L, and
an upper washcoat layer B is arranged above lower washcoat layer A and contains
   no alkaline earth compound and no alkali compound,
   platinum and palladium in a mass ratio of 10:1, as well as
   cerium oxide in a quantity of 45 to 65 g/L,
      wherein washcoat layer A is present in quantities of 250 to 350 g/L, and washcoat layer B is present in quantities of 80 to 130 g/L, and wherein the quantity g/L respectively relates to the volume of the support body.

The catalytically-active washcoat layers A and B are applied to the support body in accordance with the customary dip coating methods or pump and suck coating methods with subsequent thermal post-treatment (calcination and, where applicable, reduction using forming gas or hydrogen). These methods are sufficiently known from the prior art.

The necessary coating suspensions can be obtained in accordance with methods known to the person skilled in the art. The components, such as cerium oxide, alkaline earth and/or alkali compound, precious metals carried on suitable substrate materials, as well as manganese oxide or another manganese compound, are suspended in the appropriate quantities in water and ground in a suitable mill—in particular, a ball mill—to a particle size of d₅₀=3 to 5 μm. It is preferable to add manganese in the form of manganese carbonate to the coating suspension in the last step, i.e., directly prior to grinding.

The nitrogen oxide storage catalysts according to the invention are very well-suited for the conversion of NOₓ in exhaust gases of motor vehicles that are operated with lean-burn engines, such as diesel engines. They achieve a good NOx conversion at temperatures of approx. 200 to 450° C., without the NOx conversion being negatively affected at high temperatures. The nitrogen oxide storage catalysts according to the invention are thus suitable for Euro 6 applications.

The present invention thus also relates to a method for converting NO in exhaust gases of motor vehicles that are operated with lean-burn engines, such as diesel engines, which method is characterized in that the exhaust gas is guided over a nitrogen oxide storage catalyst composed of at least two catalytically-active washcoat layers on a support body, wherein
a lower washcoat layer A contains cerium oxide, an alkaline earth compound and/or an alkali compound, platinum and palladium, as well as manganese oxide; and
an upper washcoat layer B arranged above washcoat layer A contains cerium oxide, as well as platinum and palladium, and is free of alkali compounds and alkaline earth compounds.

Embodiments of the method according to the invention with respect to the nitrogen oxide storage catalyst correspond to the descriptions above.

The invention is explained in more detail in the examples and figures below.

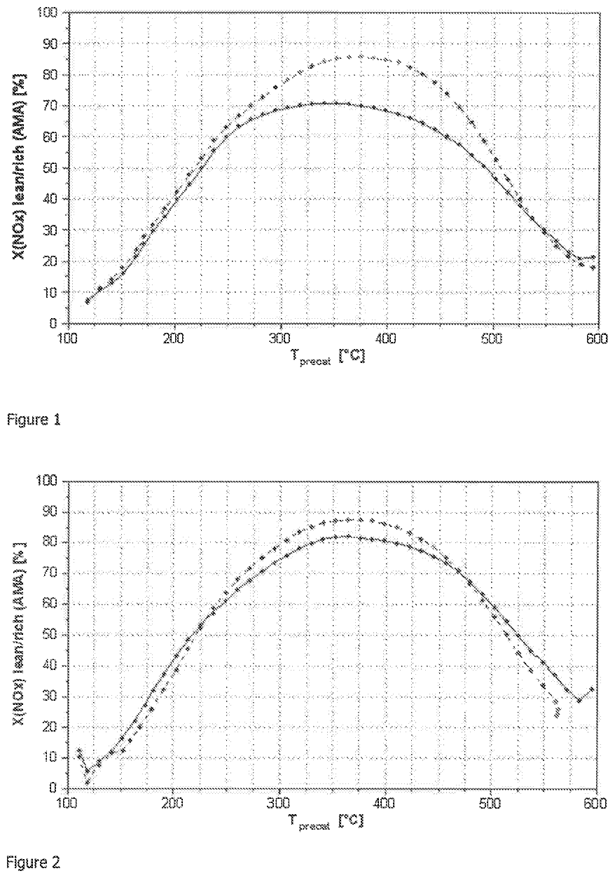

FIG. 1: NOx conversion of catalysts K1 (dashed line) and VK1 (solid line) as a function of the temperature.

FIG. 2: NOx conversion of catalysts K2 (solid line) and K3 (dashed) as a function of the temperature.

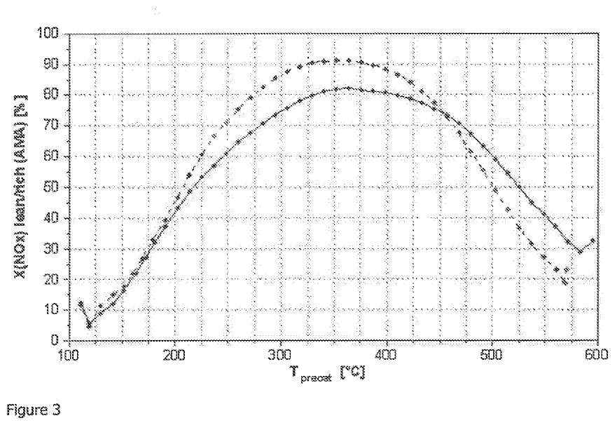

FIG. 3: NOx conversion of catalysts K2 (solid line) and K4 (dashed) as a function of the temperature.

### EXAMPLE 1

a) In order to produce a catalyst according to the invention, a honeycombed ceramic substrate is coated with a first washcoat layer A containing Pt and Pd carried on aluminum oxide, cerium oxide in a quantity of 125 g/L, 21 g/L barium oxide, 15 g/L magnesium oxide, and 7.5 g/L MnO in the form of manganese carbonate. In this case, the loading of Pt and Pd amounts to 1.236 g/L (35 g/ft³) and 0.124 g/L (3.5 g/ft³), and the total loading of the washcoat layer is approximately 293 g/L in relation to the volume of the ceramic substrate.

b) Another washcoat layer B, which also contains Pt and Pd carried on aluminum oxide, as well as Rh carried on a lanthanum-stabilized aluminum oxide, is applied to the first washcoat layer. The loading of Pt, Pd, and Rh in this washcoat layer amounts to 1.236 g/L (35 g/ft³), 0.124 g/L (3.5 g/ft³), and 0.177 g/L (5 g/ft³). The washcoat layer B also contains 55 g/L of cerium oxide in the case of a washcoat loading of layer B of approximately 81 g/L.

The catalyst thus obtained is referred to below as K1.

### Comparative Example 1

Example 1 was repeated, with the difference that washcoat layer A did not contain any manganese oxide. The catalyst thus obtained is referred to below as VK1.

Determining the NOx conversion of K1 and VK1

a) K1 and VK1 were first aged for 16 h at 800° C. in a hydrothermal atmosphere.
b) The NOx conversion of K1 and VK1 as a function of the temperature upstream of the catalyst was determined in a model gas reactor in the so-called NOx conversion test.

In this test, synthetic exhaust gas with a nitrogen monoxide concentration of 500 ppm, 10 vol % of carbon dioxide and water respectively, a concentration of 50 ppm of a short-chain hydrocarbon mixture (consisting of 33 ppm of propene and 17 ppm of propane), as well as a residual oxygen content of 7 vol %, is guided over the respective catalyst sample in a model gas reactor at a space velocity of 50 k/h, wherein the gas mixture alternately contains excess oxygen for 80 s (“lean” gas mixture with air/fuel ratio λ of 1.47) while nitrogen oxides are stored, and has an oxygen deficit for 10 s to regenerate the catalyst sample (“rich” gas mixture with air/fuel ratio λ of 0.92; by adding 5.5 vol % of carbon monoxide with simultaneous reduction of the residual oxygen content to 1 vol %).

In the process, the temperature is reduced by 7.5° C./min from 600° C. to 150° C., and the conversion during each 90-second-long lean/fat cycle is determined. FIG. 1 shows the NOx conversions determined in this way of the catalyst K1 according to the invention and of the comparison catalyst VK1. The conversion of K1 in the entire temperature range, accordingly, is above the conversion of VK1.

### EXAMPLE 2

a) In order to produce another catalyst according to the invention, a honeycombed ceramic substrate is coated with a first washcoat layer A containing Pt and Pd carried on aluminum oxide, cerium oxide in a quantity of 125 g/L, 21 g/L barium oxide, 7.5 magnesium oxide, and 7.5 g/L manganese oxide in the form of manganese carbonate. In this case, the loading of Pt and Pd amounts to 1.236 g/L (35 g/ft³) and 0.124 (3.5 g/ft³), and the total loading of the washcoat layer is approximately 299 g/L in relation to the volume of the ceramic substrate.

b) Another washcoat layer B, which also contains Pt and Pd, as well as Rh carried on aluminum oxide, is applied to the first washcoat layer. The loading of Pt, Pd, and Rh in this washcoat layer amounts to 1.236 g/L. (35 g/ft³), 0.124 g/L (3.5 g/ft³), and 0.177 g/L (5 g/ft³). The washcoat layer B also contains 55 g/L of cerium oxide in the case of a washcoat loading of layer B of approximately 94 g/L. The catalyst thus obtained is referred to below as K2.

### EXAMPLE 3

Example 2 was repeated, with the difference that washcoat layer B additionally contained 2.5 g/L manganese oxide in the form of manganese carbonate.

The catalyst thus obtained is referred to below as K3.

The NOx conversion of K2 and K3 was measured as described above. FIG. 2 shows the result.

### EXAMPLE 4

Example 2 was repeated, with the difference that washcoat layer A contained 15 g/L manganese oxide in the form of manganese carbonate.

The catalyst thus obtained is referred to below as K4.

The NOx conversion of K2 and K4 was measured as described above. FIG. 3 shows the result.

### EXAMPLES 5 THROUGH 10

Example 1 was repeated, with the difference that the quantities of cerium oxide and manganese oxide specified in Table 1 below were used.

The catalysts thus obtained are called K2 through K6.

TABLE 1

| | CeO₂ | CeO₂ | MnO | MnO |
|---|---|---|---|---|
| | Washcoat A | Washcoat B | Washcoat A | Washcoat B |
| Catalyst | [g/L] | [g/L] | [g/L] | [g/L] |
| K5 | 110 | 25 | 5 | 1 |
| K6 | 125 | 40 | 7.5 | — |
| K7 | 140 | 60 | 2.5 | — |
| K8 | 155 | 100 | 2.5 | 2.5 |
| K9 | 155 | 22 | 7.5 | 0.5 |
| K10 | 110 | 129 | 2 | 2.5 |

1. Nitrogen oxide storage catalyst composed of at least two catalytically-active washcoat layers on a support body, wherein
a lower washcoat layer A contains cerium oxide, an alkaline earth compound and/or an alkali compound, platinum and palladium, as well as manganese oxide; and
an upper washcoat layer B arranged above washcoat layer A contains cerium oxide, as well as platinum and palladium, and is free of alkali compounds and alkaline earth compounds.

2. Nitrogen oxide storage catalyst according to claim 1, characterized in that washcoat layer A contains cerium oxide in a quantity of 110 to 160 g/L.

3. Nitrogen oxide storage catalyst according to claim 1, characterized in that washcoat layer B contains cerium oxide in a quantity of 22 to 120 g/L.

4. Nitrogen oxide storage catalyst according to claim 1, characterized in that the alkaline earth compound in washcoat layer A is an oxide, carbonate, and/or hydroxide of magnesium, strontium, and/or barium.

5. Nitrogen oxide storage catalyst according to one claim 1, characterized in that the alkaline earth compound in washcoat layer A is magnesium oxide, barium oxide, and/or strontium oxide.

6. Nitrogen oxide storage catalyst according to claim 1, characterized in that the alkali compound in washcoat layer A is an oxide, carbonate, and/or hydroxide of lithium, potassium, and/or sodium.

7. Nitrogen oxide storage catalyst according to claim 1, characterized in that the alkaline earth or alkali compound in washcoat layer A is present in quantities of 10 to 50 g/L, calculated as alkaline earth or alkali oxide and in relation to the volume of the support body.

8. Nitrogen oxide storage catalyst according to claim 1, characterized in that manganese oxide is present in washcoat layer A in quantities of 1 to 10 wt % in relation to the total of washcoat layers A and B and calculated as MnO.

9. Nitrogen oxide storage catalyst according to claim 1, characterized in that manganese oxide is present in washcoat layer B in quantities of up to 2.5 wt % in relation to the total of washcoat layers A and B and calculated as MnO.

10. Nitrogen oxide storage catalyst according to claim 1, characterized in that the ratio of platinum to palladium in washcoat layer A and in washcoat layer B is respectively 4:1 to 18:1, independently of each other.

11. Nitrogen oxide storage catalyst according to claim 1, characterized in that washcoat layer B contains rhodium.

12. Nitrogen oxide storage catalyst according to claim 11, characterized in that rhodium is present in quantities of 0.003 to 0.35 g/L in relation to the volume of the support body.

13. Nitrogen oxide storage catalyst according to claim 1, characterized in that the total washcoat loading of the support body is 300 to 600 g/L in relation to the volume of the support body.

14. Nitrogen oxide storage catalyst according to claim 1, characterized in that it contains
a lower washcoat layer A
cerium oxide in a quantity of 100 to 160 g/L,
platinum and palladium in a mass ratio of 10:1,
magnesium oxide and/or barium oxide; as well as
manganese oxide in a quantity of 10 to 20 g/L, and
an upper washcoat layer B arranged above lower washcoat layer A and containing
no alkaline earth compound and no alkali compound,
platinum and palladium in a mass ratio of 10:1, as well as
cerium oxide in a quantity of 45 to 65 g/L,
wherein washcoat layer A is present in quantities of 250 to 350 g/L, and washcoat layer B is present in quantities of 80 to 130 g/L, and wherein the quantity g/L respectively relates to the volume of the support body.

15. Method for converting NOₓ in exhaust gases of motor vehicles that are operated with lean-burn engines, characterized in that the exhaust gas is guided over a nitrogen oxide storage catalyst according to one claim 1.
